(19) United States
(12) Patent Application Publication
(10) Pub. No.: US 2016/0154448 A1
(43) Pub. Date: Jun. 2, 2016

(54) ELECTRONIC DEVICE AND POWER CONTROL METHOD BETWEEN ELECTRONIC DEVICES

(71) Applicant: Kabushiki Kaisha Toshiba, Tokyo (JP)

(72) Inventor: Ichiro Tomoda, Hamura Tokyo (JP)

(21) Appl. No.: 15/004,802

(22) Filed: Jan. 22, 2016

Related U.S. Application Data
(63) Continuation of application No. PCT/JP2013/082196, filed on Nov. 29, 2013.

(51) Int. Cl. G06F 1/30

(52) U.S. Cl. CPC G06F 1/305

(57) ABSTRACT

According to one embodiment, an electronic device includes a power supply circuit and one or more hardware processors. The one or more hardware processors coupled to the power supply circuit and configured to detect that the power supplied from the power supply circuit to the connection destination apparatus is in an overcurrent state, and to stop power supply from the power supply circuit to the connection destination apparatus, to detect information or a phenomenon indicative of return from the overcurrent state of the power supplied to the connection destination apparatus, and to start supply of the power from the power supply circuit to the connection destination apparatus.

### CROSS-REFERENCE TO RELATED APPLICATIONS

This application is a Continuation Application of PCT Application No. PCT/JP2013/082196, filed Nov. 29, 2013, the entire contents of which are incorporated herein by reference.

### FIELD

Embodiments described herein relate generally to an electronic device that is connected by a bidirectional communication interface and a power control method between the electronic devices.

### BACKGROUND

Electronic devices that are connected to each other with a bidirectional communication interface in accordance with a standard such as High-Definition Multimedia Interface (HDMI) and Mobile High-definition Link (MHL) are configured to transmit streams between them.

An electronic device (source apparatus) that outputs a stream to an electronic device (sink apparatus) that receives a stream, when they are connected using a cable conforming to the MHL standard. The source apparatus and the sink apparatus are configured to mutually control operation of the other apparatus, when they are connected using a cable conforming to the MHL standard. The source apparatus is configured to receive power supply from the sink apparatus (charge a battery included therein with electricity with the sink apparatus serving as power supply source), when the source apparatus is connected to the sink apparatus using a cable conforming to the MHL standard.

The sink apparatus supplies the source apparatus with a current within a range of a current capacity, while monitoring an overcurrent state (occurrence of current excess) in which the current (required from the source apparatus) flowing into the source apparatus exceeds the current capacity. The cable conforming to the MHL standard has an upper limit (current capacity) of the current supplied from the sink apparatus to the source apparatus.

The sink apparatus tries automatic recovery to apply shutdown (stop of current supply) or hiccup mode with overcurrent protection, when the sink apparatus detects an overcurrent state (occurrence of current excess).

When the sink apparatus is not recovered even by trial of automatic recovery to apply the hiccup mode and the shutdown state continues, the sink apparatus is required to reset (restart/reset) a charging (current supply) function for the source apparatus.

By contrast, reset (restart/reset) for charging (current supply) is required, also when the cause for the shutdown is solved, such as connection between the sink apparatus and the source apparatus that were connected when the shutdown occurred.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 shows an example of connection between electronic devices according to an embodiment;

FIG. 2 shows an example of a sink apparatus (first electronic device) according to an embodiment;

FIG. 3 shows an example of elements of a source apparatus (second electronic device) according to an embodiment;

FIG. 4 shows an example of transmission and reception of signals between the first electronic device and the second electronic device according to an embodiment;

FIG. 5 shows an example of current supply from the first electronic device to the second electronic device when an overcurrent occurs according to an embodiment;

FIG. 6 shows an example of current supply from the first electronic device to the second electronic device when an overcurrent occurs according to an embodiment;

FIG. 7 shows an example of current supply from the first electronic device to the second electronic device when an overcurrent occurs according to an embodiment;

FIG. 8 shows an example of detection of return from the overcurrent state in the second electronic device according to an embodiment; and

FIG. 9 shows an example of current supply from the first electronic device to the second electronic device when the overcurrent state is solved in the second electronic device according to an embodiment.

### DETAILED DESCRIPTION

In general, according to one embodiment, an electronic device comprises: a power supply circuit configured to supply power to a connection destination apparatus in accordance with a request from the connection destination apparatus connected using a bidirectional interface; and one or more hardware processors coupled to the power supply circuit and configured to detect that the power supplied from the power supply circuit to the connection destination apparatus is in an overcurrent state, and to stop power supply from the power supply circuit to the connection destination apparatus, to detect information or a phenomenon indicative of return from the overcurrent state of the power supplied to the connection destination apparatus, and to start supply of the power from the power supply circuit to the connection destination apparatus.

Embodiments will now be described hereinafter in detail with reference to the accompanying drawings.

An embodiment of the present invention will be explained hereinafter with reference to drawings. The constituent elements and structures explained hereinafter may be achieved by software with a microcomputer (processor, CPU (Central Processing Unit)), or hardware. A method for acquiring contents displayed by a monitor may be any method, such as use of spatial waves (radio waves), use of a cable (comprising an optical fiber) or a network such as an Internet protocol communication network, signal processing on a streaming image from a network, and an image transfer technique using a network function. The contents may also be referred to as stream, program, or information, and comprises images, sound, or music. The images comprises video, still pictures, or a text (information represented by characters or symbols indicated by a coded symbol string), and a combination thereof.

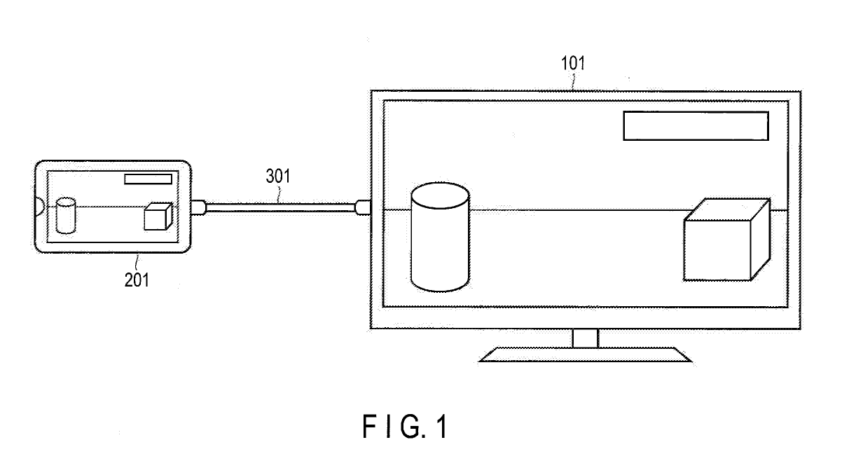

As illustrated in FIG. 1, a sink apparatus (first electronic device) 101 and a source apparatus (second electronic device) 201 are mutually connected via a bidirectional communication interface 301.

The sink apparatus 101 may be a combination of an image processing apparatus such as a broadcasting receiver (television) configured to play back a broadcasting signal or image contents held in a storage medium and a recording and playback apparatus (recorder) configured to record and play back contents, and a monitor (display). The sink apparatus 101 may also be a set-top box (STB) configured to acquire content (broadcasting signal) and to supply the content (broadcasting signal) to the image processing apparatus.

The source apparatus 201 is, for example, a mobile phone terminal comprising a display, an operating module, and a communication module, a tablet personal computer (tablet), or a portable music player, which are portable and configured to mainly play back contents (image/sound). A plurality of (at least two) source apparatuses 201 may be provided, although the source apparatuses 201 require individual authentication.

The bidirectional communication interface 301 is a communication cable conforming to, for example, the High-definition Multimedia Interface (HDMI) or Mobile High-definition Link (MHL) standard. The following explanation illustrates a representative example of using a communication cable conforming to the MHL standard.

The communication cable (hereinafter referred to as an “MHL cable”) 301 conforming to the MHL standard comprises, for example, an HDMI terminal with a shape conforming to the HDMI standard and configured to connect with the sink apparatus 101, and a terminal with a shape conforming to the micro Universal Serial Bus (micro USB) standard and configured to connect with the source apparatus 201.

The MHL standard enables transmission of a stream (video) comprising images (video) and sound (audio). In the MHL standard, a stream is output from the source apparatus 201 (the second electronic device that outputs the stream) to the sink apparatus 101 (the first electronic device that receives the stream). The sink apparatus 101 plays back the stream received from the source apparatus 201, and displays the played back image on the display.

In the MHL standard, the sink apparatus 101 and the source apparatus 201 are configured to mutually operate and control the other apparatus.

In the MHL standard, the source apparatus 201 is connected to the sink apparatus 101 with the MHL cable 301, and configured to receive power supply (charge the included battery with electricity with the sink apparatus 101 serving as the current supply source) from the sink apparatus 101. The MHL cable 301 has an upper limit (current capacity) of the current supplied from the sink apparatus 101 to the source apparatus 201. The sink apparatus 101 supplies the source apparatus 201 with a current within a range of the current capacity, while monitoring an overcurrent state (occurrence of current excess) in which the current (required from the source apparatus 201) flowing into the source apparatus 201 exceeds the current capacity.

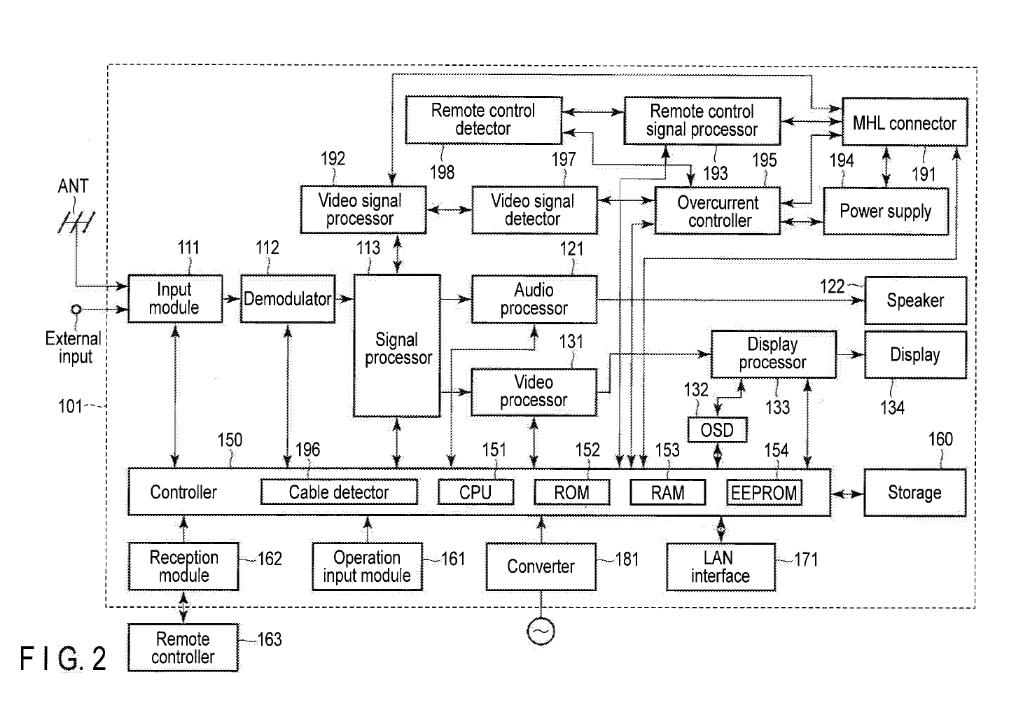

FIG. 2 illustrates an example of elements of the sink apparatus (first electronic device).

The sink apparatus 101 (television (first electronic device)) comprises an input module 111, a demodulator 112, a signal processor 113, a controller 150, an operation input module 161, a reception module 162, a network controller (LAN interface) 171, and a converter 181. The sink apparatus 101 also comprises a speaker 122, a display 134, and an MHL connector 191 connected to the MHL cable 301. The sink apparatus 101 further comprises an audio processor 121, a video processor 131, an OSD processor 132, a display processor 133, and a storage 160. The sink apparatus 101 also comprises a video signal processor 192, a remote control signal processor 193, a power supply 194, an overcurrent controller 195, a cable detector 196, a video signal detector 197, and a remote control detector 198, in relation to power supply to the source apparatus 201 connected with the MHL cable 301 and playback of contents (stream) from the source apparatus 201.

The input module 111 is configured to receive, for example, digital broadcasting signals received through an antenna ANT, such as terrestrial broadcasting signals, BS (Broadcasting Satellite) broadcasting signals, and CS (Communication Satellite) broadcasting signals. The input module 111 is also configured to receive content (external inputs) supplied, for example, through a set-top box (STB) such as a tuner compatible with subscription and pay-per-view broadcasting, or a tuner configured to select broadcasting distributed from a cable head-end, or as direct inputs.

The input module 111 tunes to (select) the received digital broadcasting signal. The input module 111 supplies the tuned digital broadcasting signal to the demodulator 112. The sink apparatus 101 may comprise a plurality of input modules (tuners) 111. In such a case, the sink apparatus 101 is configured to simultaneously receive a plurality of digital broadcasting signals/contents. The input module 111 supplies an external input through the STB or the like to the demodulator 112 without any processing.

The demodulator 112 demodulates the digital broadcasting signal input to the input module 111, in order to acquire video data (hereinafter referred to as a “stream”) such as a transport stream (TS) from the input digital broadcasting signal.

The signal processor 113 separates the stream demodulated by the demodulator 112 into, for example, a digital image signal, a digital sound signal, and other data signals (such as EPG (Electric Program Guide), electric program guide information, and subtitle data). The signal processor 113 also supplies the separated digital sound signal to the audio processor 121. The signal processor 113 also supplies the separated digital image signal to the video processor 131.

The signal processor 113 is configured to convert the stream into data configured to be recorded (recording stream), based on control of the controller 150 described later. The signal processor 113 is also configured to supply the recording stream to the storage 160 or another module, based on control of the controller 150. The signal processor 113 is also configured to convert (transcode) a bit rate of the stream from the bit rate set in the original (broadcasting signal/content) into another bit rate. Specifically, the signal processor 113 is configured to transcode (convert) the original bit rate of the acquired broadcasting signal/content into a bit rate lower than the original. In this manner, the signal processor 113 enables recording of the content (program) with a less capacity.

The controller 150 comprises a CPU 151, a ROM 152, a RAM 153, a nonvolatile memory (EEPPROM) 154, and the cable detector 196, in order to control operations of the modules of the sink apparatus 101.

The CPU 151 executes a program stored in the ROM 152 or the nonvolatile memory 154 in order to execute processing of operations of the modules, as a controller, based on an operating signal (input command) from the operation input module 161.

The ROM 152 stores a program used for controlling the sink apparatus 101 and a program used for achieving various functions.

The RAM 153 functions as a work memory of the CPU 151, and temporarily stores a result of calculation by the CPU 151, and input/read data, and the like.

The EEPROM (nonvolatile memory) 154 stores various setting information and programs.

The cable detector 196 applies a predetermined voltage to a resistor between sensing terminals in order to detect that the cable connected to the connector 191 is the MHL cable 301 and connection of the MHL cable 301, based on the MHL standard.

The operation input module 161 comprises an operation key configured to generate an operating signal in response to an operation input by the user. The operation input module 161 supplies an operating signal to the controller 150.

The reception module 162 comprises a sensor configured to receive an operating signal supplied from the remote controller 163 by the infrared (Ir) method. The reception module 162 is configured to supply the received signal to the controller 150. The controller 150 is configured to receive the supplied signal from the reception module 162, amplify the received signal, and subject the amplified signal to analog-to-digital conversion in order to decode the original operating signal transmitted from the remote controller 163.

The remote controller 163 is configured to generate an operating signal based on a user's operation input. The remote controller 163 is configured to transmit the generated operating signal to the reception module 162 by infrared communication. The reception module 162 and the remote controller 163 may be configured to transmit and receive an operating signal by another wireless communication such as radio waves (RF).

The network controller (LAN (Local Area Network) interface) 171 is configured to connect to the Internet (network) 1 configured to connect through a LAN or a wireless LAN, in order to communicate with another apparatus on the network 1. In this manner, the television 101 is configured to transmit and receive information to and from any apparatus, a content supply source, or various data servers configured to connect through the network 1. In this manner, the television 101 is configured to acquire and play back content (stream) held in the content supply source, data server, or any domestic apparatus which are connected through the network controller 171.

The converter 181 is configured to receive power from a commercial power supply, convert an alternating-current power into a direct-current power, and supply the current to the modules in the sink apparatus 101. The converter 181 is also configured to supply a predetermined power (5 V, 1.4 A) to the source apparatus 201 connected to the sink apparatus 101 through the MHL cable 301 connected to the connector 191, via the power supply 194 described later.

The sink apparatus 101 is configured to convert a digital sound signal into an analog signal in order to convert the signal to a signal (audio signal) of a format configured to be played back by the speaker 122, in the audio processor 121 under the control of the controller 150. The sink apparatus 101 is also configured to convert an image signal into an image signal of a format configured to be played back by the display 134, in the video processor 131 under the control of the controller 150. The OSD processor 132 is configured to generate an OSD (On Screen Display) signal for displaying notifying information superimposed on a display signal from the video processor 131, based on a data signal supplied from the signal processor 113 or a control signal (control command) supplied from the controller 150, under the control of the controller 150. The notifying information is, for example, a graphical user interface (GUI) display, a subtitle display, a time display, presence/absence of receipt in a social networking service to the source apparatus 201. The display processor 133 is configured to superimpose an OSD signal from the OSD processor 132 on a display signal from the video processor 131 after image quality adjusting processing on, for example, color, luminance, sharpness, and contrast, and supply the superimposed signals to the display 134, under the control of the controller 150.

The sink apparatus 101 may comprise an output terminal which outputs an image signal, instead of the display 134. The sink apparatus 101 may comprise an output terminal which outputs an audio signal, instead of the speaker 122. The television 101 may comprise an output terminal which outputs a digital image signal and a digital sound signal.

The storage 160 comprises a storage medium which stores contents. The storage 160 is, for example, a hard disk drive (HDD), an SDD (Solid State Drive), or a semiconductor memory. The storage 160 is configured to store supplied recording streams and text data from the signal processor 113.

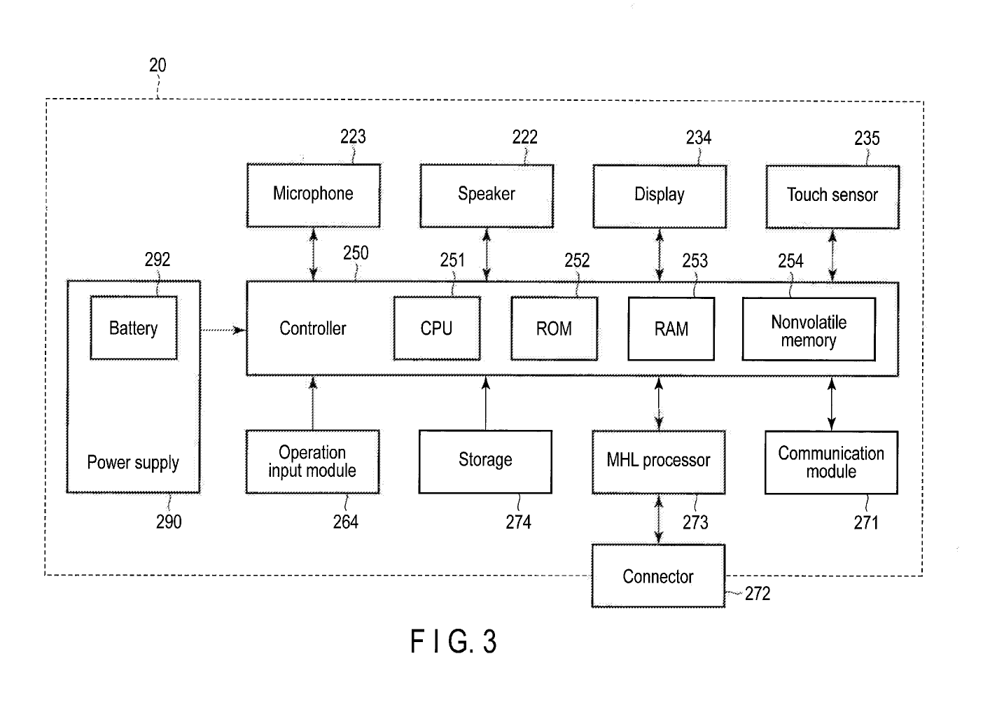

FIG. 3 illustrates an example of the source apparatus 201.

The source apparatus 201 comprises, for example, a controller 250, an operation input module 264, a communication module 271, an MHL processor 273, and a storage 274. The source apparatus 201 also comprises a speaker 222, a microphone 223, a display 234, a touch sensor 235 united with the display 234, and a power supply 290 configured to attach a battery (secondary battery) 292 thereto.

The controller 250 comprises a CPU 251, a ROM 252, a RAM 253, and a nonvolatile memory 254, and is configured to control operations of the modules of the source apparatus 201.

The controller 250 is configured to perform various processing based on operating signals supplied from the operation input module 264 or the touch sensor 235. The controller 250 is also configured to control the modules, start the application, and performs processing (execution of the function) provided by the application, in accordance with control commands supplied from the sink apparatus 101 through the MHL processor 273 via the MHL cable 301 (the CPU 251 may perform the processing).

The CPU 251 is configured to perform various calculations. The CPU 251 is also configured to achieve various functions by executing programs stored in the ROM 252 or the nonvolatile memory 254. The CPU 251 is also configured to perform various processing for applications/programs stored in the storage 274.

The ROM 252 stores a program for controlling the sink apparatus 101, and a program for achieving various functions.

The RAM 253 functions as a work memory of the CPU 251. Specifically, the RAM 253 stores a result of calculation by the CPU 251, read data by the CPU 251, and data necessary for authentication with the sink apparatus 101 by the MHL processor 273.

The nonvolatile memory 254 stores various setting information, programs, a result of authentication by the MHL processor 273 with the sink apparatus 101, and an IP address assigned by the sink apparatus 101.

The controller 250 is configured to generate a display image signal for displaying various screen displays in order to display the signal on the display 234, in accordance with the application executed by the CPU 251. Specifically, the display 234 is configured to play back video (graphics), still images, or character information, based on the supplied video signal (Video). The controller 250 is configured to generate a playback sound signal such as various sounds, and to output the sound signal by the speaker 222, in accordance with the application executed by the CPU 251. The speaker 222 plays back sound (audio/voice) based on the supplied audio signal (Audio).

The microphone 223 is configured to collect sound around the source apparatus 201, and to generate the audio signal. The audio signal is subjected to analog-to-digital conversion, thereafter converted into audio data by the controller 250, and temporarily stored in the RAM 253. The audio data is subjected to digital-to-analog conversion, if necessary, and thereafter converted (played back) into voice/audio sound by the speaker 222. The audio data is subjected to analog-to-digital conversion, and thereafter used as a control command by sound recognition processing.

The display 234 comprises, for example, a liquid crystal display device comprising a liquid crystal display panel comprising a plurality of pixels which are arranged in a matrix manner, and a backlight configured to illuminate the liquid crystal panel.

The touch sensor 235 is configured to generate an operating signal and supply the operating signal to the controller 250, based on an operation (a user input corresponding to the picture display) on the picture on the display 234.

The operation input module 264 comprises, for example, keys configured to generate an operating signal in accordance with an operation input by the user. The operation input module 264 comprises, for example, a volume adjusting key for adjusting the volume, a luminance adjusting key for adjusting the display luminance of the display 234, and a power key for switching (turning on/off) the power state of the tablet 201. When the source apparatus 201 comprises, for example, a USB terminal or a Bluetooth (registered trademark) module, the operation input module 264 receives an operating signal from an input device connected by USB or Bluetooth, and supplies the operating signal to the controller 250.

The communication module 271 is configured to communicate with another apparatus on the network with a LAN or wireless LAN. In this manner, the source apparatus 201 is configured to acquire and play back content (stream) held in the content supply source, data server, or any domestic apparatus which are connected through the network.

The MHL processor 273 is configured to process a signal transmitted to and received from the sink apparatus 101 connected through the MHL cable 301 connected to the connector 272, based on the MHL standard. The MHL processor 273 is configured to output a display image signal and a playback sound signal from the controller 250 to the sink apparatus 101 through the MHL cable 301 connected to the connector 272, when a stream is supplied to the sink apparatus 101. The MHL processor 273 is also configured to request the sink apparatus 101 to supply a current for charging the battery 292 in the power supply 290 with electricity.

The storage 274 comprises a hard disk drive (HDD), a solid state drive (SSD), or a semiconductor memory or the like. The storage 274 is configured to store a program executed by the CPU 251 of the controller 250, applications, contents such as video, and various data.

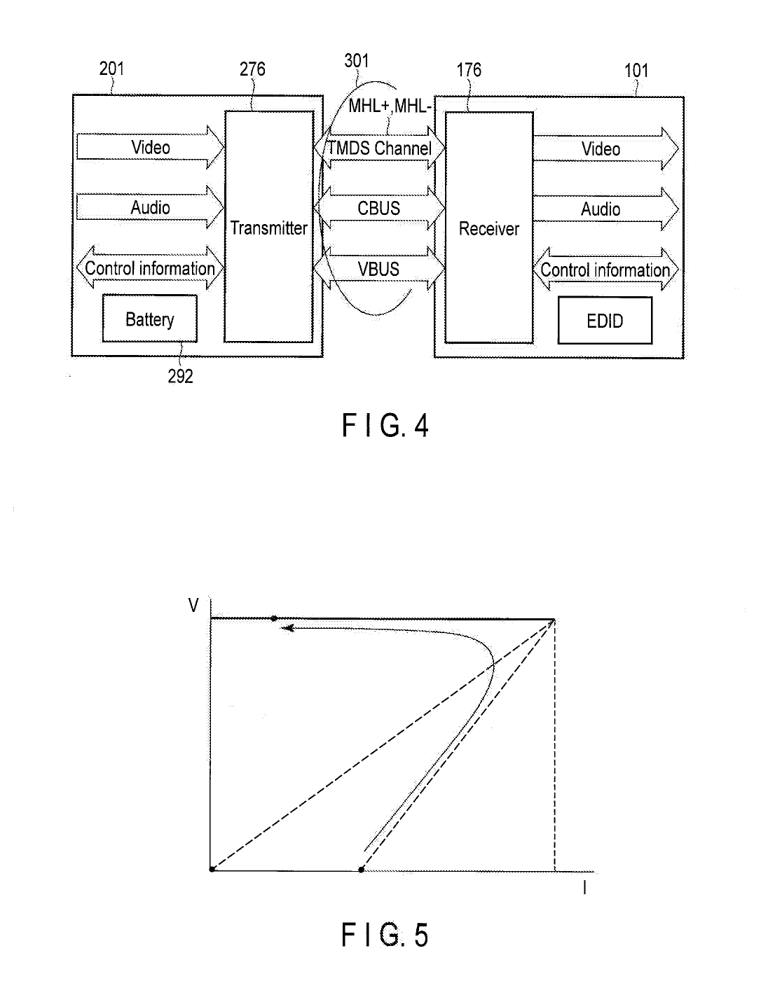

FIG. 4 illustrates an example of mutual communications between the sink apparatus 101 and the source apparatus 201 which are connected through the MHL cable.

The MHL processor 273 of the source apparatus 201 comprises a transmitter 276 and a receiver (not illustrated). The sink apparatus 101 comprises a transmitter (not illustrated) and the receiver 176.

The MHL cable 301 comprises five lines, that is, a VBUS (power) line, an MHL−(differential pair [− (minus)]) line, an MHL+(differential pair [+ (plus)]) line, a CBUS (control signal) line, and a GND (ground) line, when a micro USB terminal is applied as a connector in mounting.

The VBUS line functions as a power supply line configured to transmit power from the sink apparatus 101 to the source apparatus 201. Specifically, in the connection in FIG. 4, the sink apparatus 101 supplies power of +5 V to the source apparatus 201 through the VBUS line. In this manner, the source apparatus 201 operates with the power supplied from the sink apparatus 101. The source apparatus 201 is configured to charge the battery 292 with power (5 V, 1.4 A) supplied from the sink apparatus 101. The source apparatus 201 operates with power supplied from the battery 292 when the source apparatus 201 operates singly.

The CBUS line is used for bi-directionally transmitting, for example, a Display Data Channel (DDC) command, an MHL sideband channel (MSC) command, or a desired control command corresponding to the application.

The DDC command is used for reading data held in Extended Display Identification Data (EDID) serving as information prepared in advance in the sink apparatus 101, and authenticating High-bandwidth Digital Content Protection (HDCP) serving as a method for encoding signals mutually transmitted between the apparatuses, in order to notify the other apparatus (source apparatus 201) of specifications (display capacity) in the display or the like.

HDCP is a method for encoding a signal transmitted between the apparatuses. The sink apparatus 101 and the source apparatus 201 are configured to transmit and receive a key or the like in order to perform mutual authentication in accordance with a procedure defined by HDCP. The sink apparatus 101 and the source apparatus 201 mutually exchange encoded signals, when the apparatuses are mutually authenticated.

The MSC command is used for reading and writing data to and from various registers, transmitting MHL conformance data or the like in the application held in the other apparatus, and notifying the sink apparatus 101 of receipt of a call or an e-mail received by the source apparatus 201.

A request of power supply from the source apparatus 201 to the sink apparatus 101 is assigned to the RCP command of the CBUS line.

The source apparatus 201 is configured to analyze the EDID acquired from the sink apparatus 101, and recognize display information configured to indicate the format such as resolution, color depth, and transmission frequency configured to be processed (displayed) in the sink apparatus 101. The source apparatus 201 generates a stream in the format with the resolution, color depth, and transmission frequency configured to be processed by the sink apparatus 101.

The lines MHL+ and MHL− function as a twist pair. For example, the lines MHL+ and MHL− function as TMDS channels configured to transmit data by TMDS (Transition Minimized Differential Signaling). The lines MHL+ and MHL− are configured to transmit a synchronizing signal (MHL clock) in the TMDS method.

The source apparatus 201 is configured to output a stream to the sink apparatus 101 through the TMDS channel. Specifically, the source apparatus 201 is configured to transmit a stream obtained by converting the image (display picture) to be displayed on the display 234 and the sound to be output from the speaker 222 for transmission to the sink apparatus 101 to the sink apparatus 101. The sink apparatus 101 performs signal processing on the stream received through the TMDS channel, and plays back the stream.

In the source apparatus 201 and the sink apparatus 101 which are mutually connected through the MHL cable 301 illustrated in FIG. 1 to FIG. 4, the battery 292 of the source apparatus 201 is supplied with a predetermined current, through the power supply 194 and the MHL connector 191 of the sink apparatus 101 and the MHL cable 301, in accordance with a power supply request from the source apparatus 201. The current from the power supply 194 of the sink apparatus 101 is used for operating the source apparatus 201 and charging the battery 292 with electricity.

By contrast, there are cases where the current requested by the source 201 exceeds the predetermined current (in power [5 V, 1.4 A]) to be supplied through the MHL cable 301, due to the data size of the stream played back by the source apparatus 201, such as the number of pixels (display size of the picture) and resolution.

When the current requested by the source apparatus 201 exceeds the predetermined current to be supplied through the MHL cable 301, a foldback overcurrent protection is performed in order to reduce the current to a fraction of the rated current (or zero) at the time when an overcurrent is detected, as shown in FIG. 5 for example, under the control of the overcurrent detector (controller) 195 configured to monitor whether the current supplied from the power supply 194 to the source apparatus 201 in accordance with a request from the source apparatus 201 exceeds the predetermined limit current (limit value).

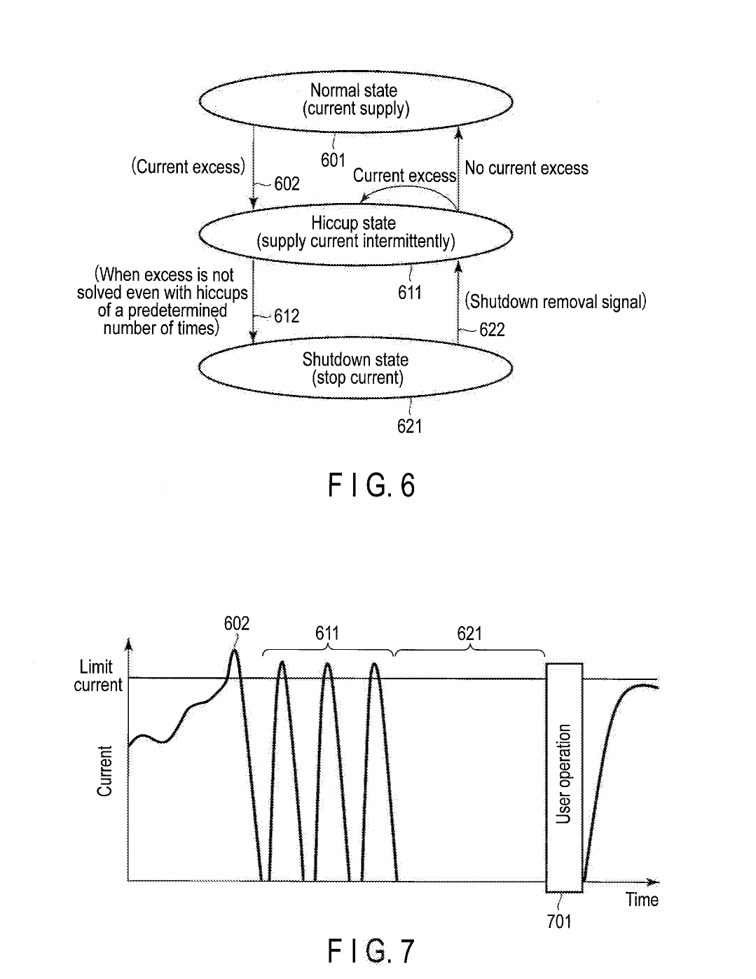

After the current is widely reduced by the foldback overcurrent protection, hiccup state control 611, an example of which is illustrated in FIG. 6, is tried, in order to check whether an overcurrent state (current excess) 602 in which the current exceeds the predetermined limit current can be corrected. If the excess is not corrected even with the hiccup state control 611 of a predetermined number of times, the hiccup state control 611 is stopped, and the apparatus goes into a state (shutdown state) 621 in which the current is regularly shut off.

When the apparatus cannot return to the normal state 601 even with a predetermined number of times of trials of automatic recovery to which the hiccup state control 611 is applied and the shutdown state 621 continues, the sink apparatus 101 is required to reset (restart/reset) the current supplying function (charging function) for the source apparatus 201. For example, reset (restart/reset) for current supply (charging) is required also when the cause of the shutdown state 621 is solved, for example, connection between the sink apparatus 101 and the source apparatus 201 which were connected when the shutdown occurred.

However, because reset (restart/reset) for current supply (charging) often requires a troublesome process for the user, such as various procedures and check on the wiring, it is required to automatic recovery of the current supply to the source apparatus 201 which was stopped by the overcurrent protection to the normal state 601.

Based on such a background, a shutdown removal signal 622 illustrated in FIG. 6 is output, in order to try start (return to the normal state 601) from the hiccup state 611, when a user's operation 701 is detected, for example, information or a phenomenon “which indicates return from the cause of overcurrent” described later, as illustrated in FIG. 7 as an example.

The information or phenomenon “which indicates return from the cause of overcurrent” is, for example, presence/absence of an image signal from the source apparatus 201 by the video signal detector 197.

A shutdown removal signal is output to the overcurrent controller 195, when the video signal processor 192 receives an MHL image signal input through the MHL connector 191 from the source apparatus 201, based on the MHL standard, the video signal detector 197 checks presence/absence of an image signal supplied to the signal processor 113 of the sink apparatus 101, and the video signal detector 197 detects that no image signal is received. Specifically, the overcurrent controller 195 escapes from the shutdown state, and returns to the hiccup mode again, when the overcurrent controller 195 receives the shutdown removal signal from the video signal detector 197. In checking presence/absence of an image signal, “return from the cause of overcurrent” is determined, for example, also when the video signal detector 197 detects change in the format of the image signal, such as change in the image size or resolution. For example, change in the format is detected from the information “info” in the image signal.

The information or phenomenon “which indicates return from the cause of overcurrent” is, for example, transmission of a specific remote control command of a type that may change (reduce the power consumption) the power consumption from the sink apparatus 101 to the source apparatus 201 by the remote control detector 198, such as a Stop command, a Pause command, a Mute command, an Eject command, a Power Off command, or a Standby command, or an operation input of input switching in the sink apparatus 101.

Specifically, a shutdown removal signal is output to the overcurrent controller 195, in order to transition to trial of the hiccup state as described above, when the remote control detector 198 detects the possibility of change in the power consumption in the source apparatus 201 (reduction in current requested by the source apparatus 201 of the sink apparatus 101 is expected) by detecting transmission of a specific MHL remote control signal from the remote control signal processor 193 to the MHL connector 191.

The information or phenomenon “which indicates return from the cause of overcurrent” is, for example, release of connection (disconnection) of the MHL cable 301 with the MHL connector 191 by the cable detector 196, that is, disconnection of the MHL cable 301 from the MHL connector 191, for example, that the source apparatus 201 is expected to be exchanged.

In this manner, the overcurrent controller 195 outputs the shutdown removal signal, in order to transition to trial of the hiccup state as described above.

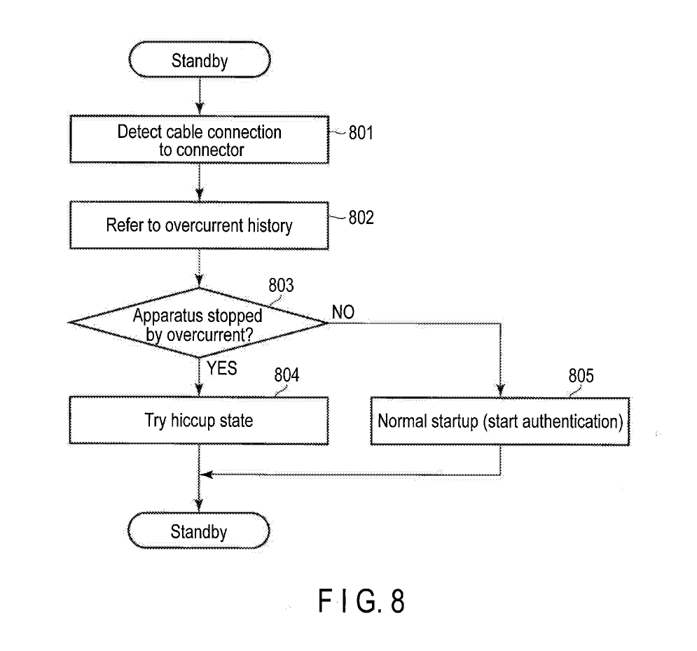

When the cable detector 196 detects release of connection (disconnection of the cable) of the MHL cable 301 with the MHL connector 191, it is required to distinguish the release of connection from ordinary startup (new MHL connection). For this reason, as illustrated in FIG. 8 as an example, for example, when the cable detector 196 detects attachment of the MHL cable 301 to the MHL connector 191 [801], the cable detector 196 refers to an overcurrent detection history held in the EEPROM 154 [802], and the hiccup state described above is tried, when the cable detector 196 detects that the apparatus is in a shutdown state by detection of an overcurrent [803-YES]. The overcurrent detection history is determined based on, for example, a MAC (Media Access Control) address of the source apparatus 201 or the IP address assigned by the sink apparatus 101 [804].

By contrast, when the apparatus has no overcurrent detection history [803-NO], normal startup is performed [805].

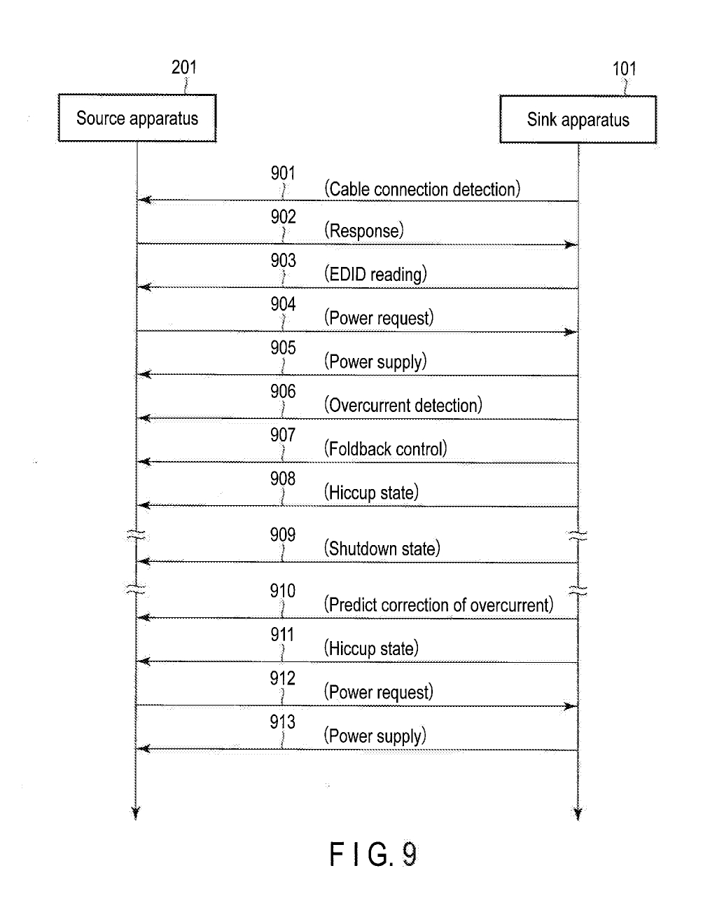

FIG. 9 illustrates an example of a sequence of current supply between the sink apparatus 101 and the source apparatus 201 which are connected with the MHL cable 301. Because the sink apparatus 101 and the source apparatus 201 are configured to mutually transmit information, part of processing may be executed substantially simultaneously or in the reversed order.

In 901 (cable connection detection), the sink apparatus 101 detects that the source apparatus 201 is connected thereto with the MHL cable 301.

In 902 (the sink apparatus 101 recognizes the source apparatus 201 as an MHL-conformant apparatus), the source apparatus 201 notifies the sink apparatus 101 that the source apparatus 201 is an MHL-conformant apparatus.

In 903 (EDID reading), the source apparatus 201 reads an EDID of the sink apparatus 101, and determines conditions of the stream transmitted to the sink apparatus through the MHL cable 301.

In 904 (power request), the source apparatus 201 requests the sink apparatus 101 to supply power.

In 905 (power supply), the sink apparatus 101 supplies power (5 V, 1.4 A) to the source apparatus 201 within a range of supply current with the MHL cable 301.

If the sink apparatus 101 detects that the current of the power supplied to the source apparatus 201 enters an overcurrent state in 906 (overcurrent detection), the sink apparatus 101 temporarily shuts off the supply current by foldback control in 907 (foldback control).

In 908 (hiccup state), the sink apparatus 101 supplies current to the source apparatus 201 in a hiccup state.

In 909 (shutdown state), the sink apparatus 101 stops current supply to the source apparatus, when current supply to the source apparatus 201 cannot be resumed with the hiccup state. In 910 (predict return from the cause of overcurrent), the sink apparatus 101 waits for occurrence of information or phenomenon “which indicates correction of the cause of overcurrent” which enables current supply to the source apparatus.

In 911 (hiccup state), after the sink apparatus 101 detects information or phenomenon “which indicates return from the cause of overcurrent”, the sink apparatus 101 outputs a shutdown removal signal, and tries current supply to the source apparatus 201 by the hiccup state.

In 913 (power supply), the sink apparatus 101 supplies power to the source apparatus, in response to a power request in 912 (power request) from the source apparatus, when current is supplied to the source apparatus 201 by the hiccup state.

The information or phenomenon “which indicates return from the cause of overcurrent” is also, for example, detection of an input of the source apparatus 201 to the touch sensor 235, which indicates escape of the source apparatus 201 from the sleep state in which the source apparatus 201 is connected with the MHL cable 301 only for charging. Specifically, the sink apparatus 101 transitions to trial of the hiccup state described above, when the controller 150 or the remote control detector 198 of the sink apparatus 101 detects transmission (an operation input with the touch sensor 235) of a predetermined control command with which change in power consumption (requested current) in the source apparatus 201 is expected.

As described above, current supply from the power supply source apparatus to the power supply destination apparatus is recovered, when the cause of shutdown is solved, in power supply between connected apparatuses return from the MHL standard and configured to mutual power supply.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions.

The accompanying claims and their equivalents are intended to cover such forms or modifications as would fall within the scope and spirit of the inventions.

What is claimed is:

1. An electronic device comprising:
a power supply circuit configured to supply power to a connection destination apparatus in accordance with a request from the connection destination apparatus connected using a bidirectional interface; and
one or more hardware processors coupled to the power supply circuit and configured to detect that the power supplied from the power supply circuit to the connection destination apparatus is in an overcurrent state, and to stop power supply from the power supply circuit to the connection destination apparatus, to detect information or a phenomenon indicative of return from the overcurrent state of the power supplied to the connection destination apparatus, and to start supply of the power from the power supply circuit to the connection destination apparatus.

2. The electronic device of claim 1, wherein the one or more hardware processors is further configured to check that the overcurrent state is solved by first startup control, when the power supply from the power supply circuit to the connection destination apparatus is tried.

3. The electronic device of claim 2, wherein the one or more hardware processors is configured to detect stop of an input of an image signal from the connection destination apparatus.

4. The electronic device of claim 2, wherein the one or more hardware processors is configured to detect change in format of an image signal from the connection destination apparatus.

5. The electronic device of claim 2, wherein the one or more hardware processors is configured to detect an input of a control instruction causing reduction in power consumption in the connection destination apparatus.

6. The electronic device of claim 5, wherein the control instruction comprises one of a stop command, a pause command, a mute command, an eject command, a power off command, and a standby command.

7. The electronic device of claim 2, wherein the one or more hardware processors is configured to detect release of connection to the connection destination apparatus with the bidirectional interface.

8. A power control method of an electronic device, comprising:
detecting an overcurrent state of a power supplied by a power supplying module configured to supply power to a connection destination apparatus in accordance with a request from the connection destination apparatus connected using a bidirectional interface;
stopping power supply from the power supplying module to the connection destination apparatus; and
detecting information or a phenomenon indicative of return from the overcurrent state of the power supplied to the connection destination apparatus, and starting supply of the power from the power supplying module to the connection destination apparatus.
